(19) United States
(12) Patent Application Publication
(10) Pub. No.: US 2014/0156178 A1
(43) Pub. Date: Jun. 5, 2014

(54) ROAD MARKER RECOGNITION DEVICE AND METHOD

(71) Applicant: HYUNDAI MOTOR COMPANY, Seoul (KR)

(72) Inventor: Kyung Ho Yoo, Seoul (KR)

(73) Assignee: HYUNDAI MOTOR COMPANY, Seoul (KR)

(21) Appl. No.: 13/858,341

(22) Filed: Apr. 8, 2013

(30) Foreign Application Priority Data
Dec. 4, 2012 (KR) 10-2012-0139616

(51) Int. Cl. G01C 21/32

(52) U.S. Cl. CPC G01C 21/32
USPC 701/409

(57) ABSTRACT

Disclosed is a road surface marker recognition device and method. The device includes an infrared transceiver that is configured to irradiate an infrared beam on a road surface and receive the reflected beam to detect a distance from a road surface and a strength of the reflected beam. The device further includes a controller that is configured to create a road map of the road using distance information, signal strength information, and speed information of a vehicle to define a marker shape of the road. Furthermore, the controller is configured to compare the defined marker shape with stored marker information to determine a definition of the marker shape and output the marker shape definition.

### CROSS-REFERENCE TO RELATED APPLICATION

This application is based on and claims priority from Korean Patent Application No. 10-2012-0139616, filed on Dec. 4, 2012 in the Korean Intellectual Property Office, the disclosure of which is incorporated herein in its entirety by reference.

### BACKGROUND OF THE INVENTION

1. Field of the Invention

The present invention relates a road marker recognition device, and more particularly, to a road marker recognition device capable of obtaining road information using infrared rays and recognizing a marker using the road information.

2. Description of the Related Art

Recently, research has been conducted regarding vehicle safety measures such as a safety belt and an air bag capable of minimizing driver injury during vehicle accidents. Specifically, the research has involved methods of predicting potential accidents and warning the driver to prevent the accident and thereby increasing driver safety.

Conventional safety methods include an advanced safety vehicle (ASV) technology that prevents the vehicle from unintentionally changing lanes by recognizing the lane or informing the driver of various potential road obstacles by recognizing various information (e.g., a pedestrian crossing, one-way traffic, a left turn/right turn/U turn mark, and the like) marked on the road.

As a method for recognizing the information marked on the road according to the related art, an image sensor (e.g., an imaging device) has been widely used. However, when two vehicles are being driven at a substantially small distance from each other, a road image may not be captured, and thus, the information marked on the road may not be recognized correctly. The imaging device may also not capture images during wet weather conditions or in dark lighting. In addition, an algorithm and a processing logic for the marker recognition may be complex thereby increasing the time required to recognize the road obstacle. Furthermore, a specialized recognition algorithm may be required for each marker.

### SUMMARY

The present invention provides a road marker recognition device capable of more accurately recognizing information marked on a road and providing the recognized information to a driver.

In accordance with an aspect of the present invention, a road surface marker recognition device may include: an infrared transceiver executed by a controller and configured to irradiate an infrared beam and receive the reflected beam to detect a distance from a road surface and a strength of the reflected beam; a marker configuring executed by the controller and configured to create a road map using distance information and signal strength information received from the infrared transceiver and speed information of a vehicle and detect a marker shape on the road; and a matching unit, executed by the controller and configured to compare the marker shape assigned by the marker configuring unit with pre-stored marker information to determine a definition of the marker shape and output the determined definition. The marker configuring unit may be configured to obtain first position information based on a sensor coordinate system based on the infrared transceiver using the distance information, an angle at which the infrared beam is irradiated, and an angular resolution and may be configured to perform coordinate conversion of the first position information into second position information based on a moving object coordinate system. The marker configuring unit may be configured to perform coordinate conversion of the first position information into the second position information using a moving vector between a center coordinate of the vehicle and a center coordinate of the infrared transceiver. The marker configuring unit may be configured to obtain map information with a predetermined time interval using the second position information and the signal strength information and may be configured to continuously arrange generated map information in a time sequence to create the road map and configure the marker shape on the road map. The infrared transceiver may be configured to irradiate the infrared beam to a predetermined width of the road with a predetermined period using a scanning scheme.

In accordance with another aspect of the present invention, a road marker recognition method in a vehicle, may include: irradiating, by a controller, an infrared beam to a road surface; receiving, at the controller, the beam reflected from the road to obtain distance information from the road and signal strength information of the reflected beam; creating, by the controller, a road map for the road surface using the distance information, the signal strength information, and speed information of the vehicle, detecting, by the controller, a marker shape on the road surface; comparing, by the controller, the marker shape with pre-stored marker information to determine a definition of the marker shape; and outputting, by the controller, the determination result. Creating a road map for the road surface and configuring a marker shape may further include: obtaining, by the controller, first position information based on a sensor coordinate system using the distance information, an angle at which the infrared beam is irradiated, and an angular resolution; coordinate converting, by the controller, the first position information into the second position information based on a moving object coordinate system using a moving vector between a center coordinate of the vehicle and a center coordinate of an infrared transceiver; obtaining, by the controller, map information with a predetermined time interval using the second position information and the signal strength information; and continuously arranging, by the controller, the map information in a time sequence.

### BRIEF DESCRIPTION OF THE DRAWINGS

The objects, features and advantages of the present invention will be more apparent from the following detailed description in conjunction with the accompanying drawings, in which:

FIG. 1 is an exemplary diagram illustrating a road marker recognition device installed in a vehicle according to an exemplary embodiment of the present invention;

FIG. 2 is an exemplary diagram illustrating a configuration of a road surface marker recognition device according to the exemplary embodiment of the present invention;

FIG. 3 is an exemplary flow chart illustrating a road surface marker recognition method according to the exemplary embodiment of the present invention;

FIG. 4 is an exemplary diagram illustrating a method of measuring a road surface by irradiating the road surface with an infrared beam according to an exemplary embodiment of the present invention;

FIG. 5 is an exemplary diagram illustrating a relationship between the center of a vehicle and the center of a sensor when the sensor is mounted in the vehicle (e.g., a moving object) according to an exemplary embodiment of the present invention;

FIG. 6 is an exemplary diagram illustrating an example of a marker shaped on a road map according to an exemplary embodiment of the present invention; and

FIG. 7 is an exemplary diagram illustrating markers on a road surface stored in a pattern database (DB) according to an exemplary embodiment of the present invention.

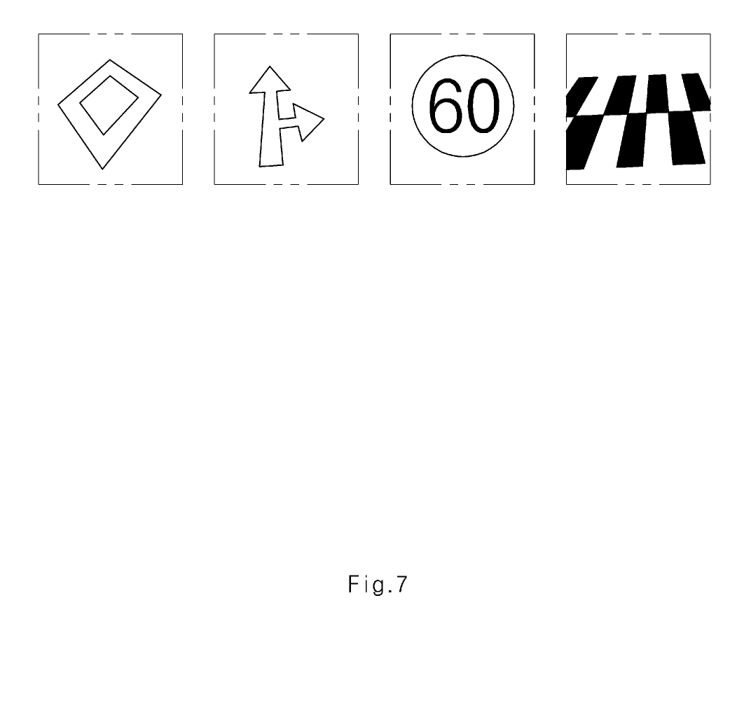

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

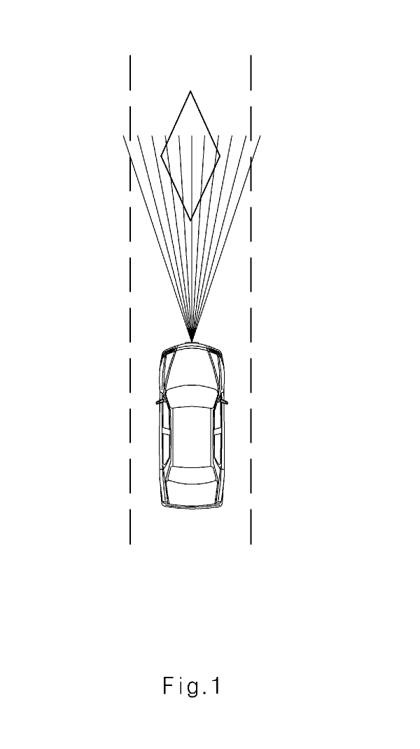

FIG. 1 is an exemplary diagram illustrating a road marker recognition device installed on a vehicle according to an exemplary embodiment of the present invention.

According to the exemplary embodiment of the present invention, an infrared irradiation device (not shown) capable of irradiating an infrared beam may be mounted in a front of a vehicle (e.g., a moving object) to irradiate the infrared beam on the road surface. Furthermore, the infrared beam irradiated on the road surface may have a specific angular resolution without irradiating as a single beam (e.g., a plane scanning scheme).

The infrared beam returned by reflection on the road surface may be received at an infrared reception device (not shown), and a distance to the road may be calculated using a time of flight (ToF) principle and the like as understood by one skilled in the art. In addition, since the strength of an infrared beam signal returned by reflection may change based on a material, a color, and the like, a road marker recognition device may measure the signal strength of the received infrared beam. The road marker recognition device according to the exemplary embodiment of the present invention may be configured to detect a marker shape marked on the road using preset information and the information obtained using the infrared beam and may be configured to compare the marker shape with marker information stored in a pattern database (DB) to determine the definition of a corresponding mark and then output a corresponding information to the driver.

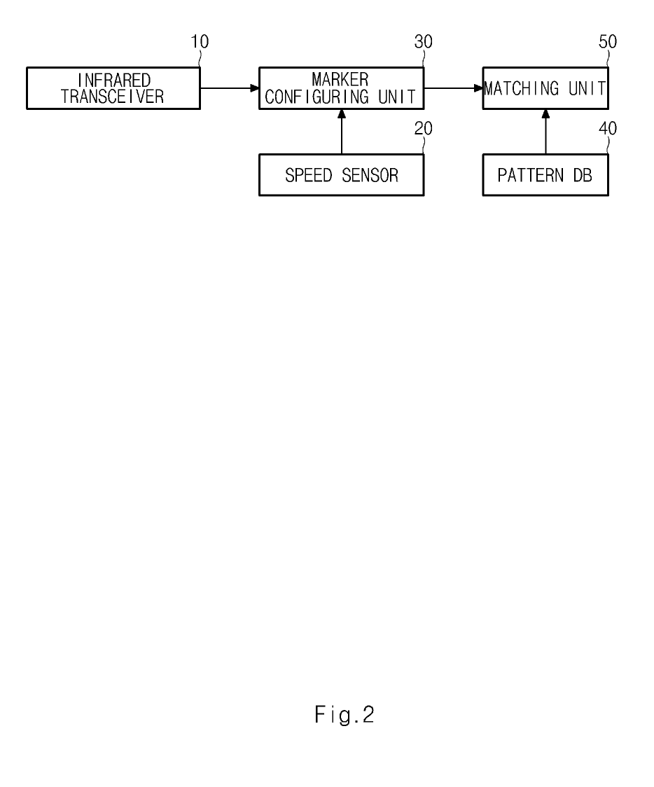

FIG. 2 is an exemplary diagram illustrating a configuration of a road marker recognition device according to the exemplary embodiment of the present invention. The road marker recognition device according to the exemplary embodiment of the present invention may include a plurality of units operated by a controller. The plurality of units may include a marker configuring unit 30 and a matching unit 50. The road marker recognition device may also include a speed sensor 20, an infrared transceiver 10, and a pattern database (DB) 40.

The infrared transceiver 10 may be configured to obtain information regarding a distance from the road and a strength of a reflection beam by irradiating the infrared beam on the road surface in a driving direction of a vehicle and may be configured to receive the infrared beam returned by reflection on the road surface to transmit the information to the marker configuring unit 30. When irradiating on the road surface with infrared beam, the infrared transceiver 10 may be configured to periodically irradiate the infrared beam at a predetermined width on the road surface using a plane scanning scheme as shown in FIG. 1.

The speed sensor 20 may be configured to measure the vehicle speed to provide the detected speed to the marker configuring unit 30. Although the exemplary embodiment of the present invention has described, for convenience of explanation, that speed information detected by the speed sensor 20 is directly transmitted to the marker configuring unit 30, the present invention is not limited thereto. For example, the speed information may be received through other controllers (e.g., mobile control unit (MCU) and the like).

The marker configuring unit 30 may be configured to create a road map and detect the marker shape by using the information (e.g., the distance information and the signal strength information) received from the infrared transceiver 10 and the speed information received from the speed sensor 20. Since the infrared transceiver 10 may be mounted at a specific position of the vehicle, the infrared beam may be irradiated on the road surface at a predetermined angle and may have a specific angular resolution.

After obtaining a position information {Pn(xn, yn), n=1˜N} based on a sensor coordinate system using the distance information r, an angle θ at which the beam is irradiated, and the angular resolution α, the marker configuring unit 30 may be configured to perform a coordinate conversion from the position information Pn to the position information Sn based on a moving object (e.g., a vehicle) coordinate system using a movement vector v between the center coordinate of a moving object (e.g., a vehicle) and the center coordinate of the infrared transceiver 10. In addition, the marker configuring unit 30 may be configured to create the map information Mn by combining the position information Sn and the information (e.g., the signal strength information) for strength of the reflection beam. The map information Mn may be repeatedly created Mn,t1˜Mn,tk at a predetermined time interval until data is collected to sufficiently recognize the road marker when the vehicle is moving at a speed of V. Thus, the marker configuring unit 30 may be configured to obtain the map information M_{n,t1}˜M_{n,tk} at the predetermined time interval using the speed information detected from the speed sensor 20 and may be configured to continuously arrange the map information in a time sequence to generate the map (e.g., road surface map) for the road surface, to define the marker shape on the road surface map.

The pattern DB 40 may be configured to store the information regarding the shape and definition of the markers marked on the road. The matching unit 50 may be configured to compare the shape of the marker configured in the marker configuring unit 30 with the marker information stored in the pattern DB 40 to determine the definition of the configured marker shape and may be configured to output the determined definition to the driver. In particular, the output may be a voice output through a speaker or may be displayed on a screen (e.g., a navigation device or the like) together with the voice notification.

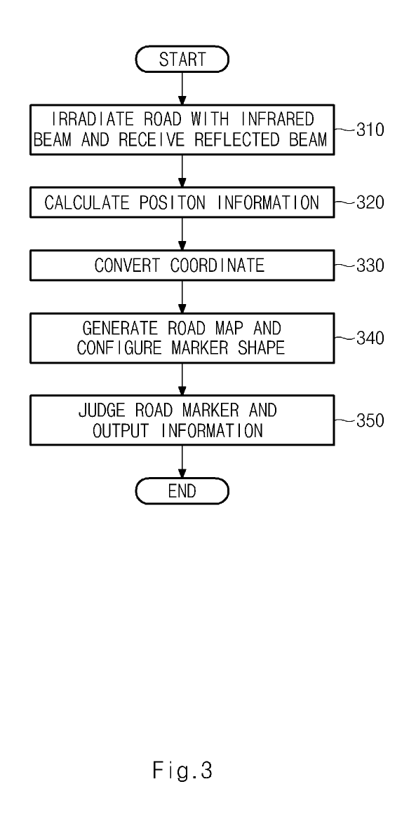

FIG. 3 is an exemplary flow chart illustrating a road surface marker recognition method according to the exemplary embodiment of the present invention.

When the vehicle is driven, the infrared transceiver 10 mounted in a front of the vehicle may be configured to periodically irradiate the infrared beam on the road surface in a driving direction of the vehicle and may be configured to receive the reflected beam from the road surface (S310). In particular, the infrared transceiver 10 may be configured to irradiate the infrared beam to a predetermined width of the road surface using a plane scanning scheme as shown in FIG. 1.

When the reflected beam is received, the infrared transceiver 10 may be configured to detect a strength of the reflection beam and a distance r1˜rn between the infrared transceiver 10 and the road surface according to each position to which the infrared beam is irradiated, and may be configured to transmit a corresponding information (e.g., distance information, signal strength information) to the marker configuring unit 30.

The marker configuring unit 30 may be configured to calculate the position information Pn of the road surface for each position to which the infrared beam is irradiated using the distance and signal strength information received from the infrared transceiver 10 and speed information received from the speed sensor 20 (S320).

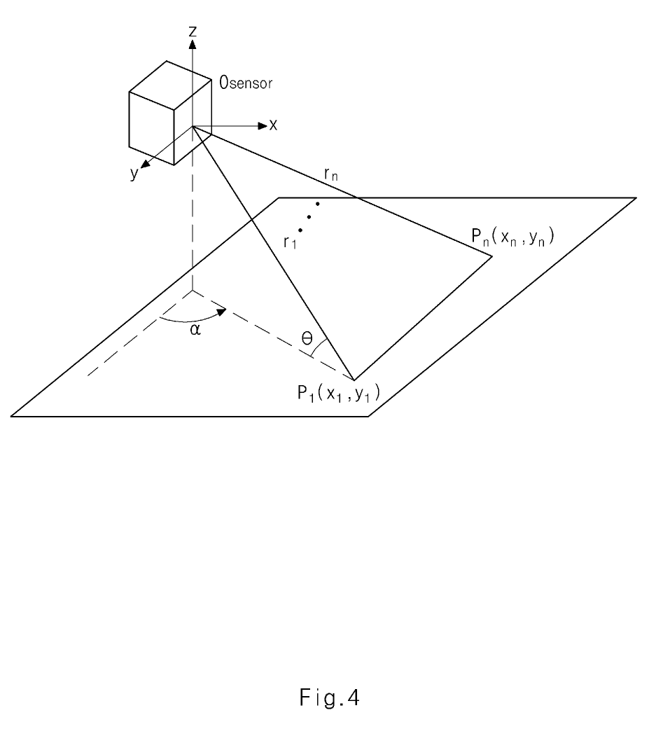

As shown in FIG. 4, when the distance between the position on the road surface at which the beam is reflected and the infrared transceiver 10 is r, an angle between the beam and the road surface is θ, and an angular resolution is α, the position information Pₙ may be calculated using the following Equation 1.

$${P}_{n} = [ \begin{matrix}{x}_{n} \\ {y}_{n}\end{matrix} ] = {r}_{n} sin ( θ ) \cdot [ \begin{matrix}sin ( α + φ \cdot ( n - 1 ) ) \\ cos ( α + φ \cdot ( n - 1 ) )\end{matrix} ] , n = 1 , … N$$

However, since the position information Pn according to the Equation is the position information based on the sensor coordinate system based on fixed specific point, when the position information is calculated during vehicle movement, the position information Pn should be converted into the position information based on the moving object (e.g., vehicle) coordinate system.

Accordingly, when the position information Pᵣ, is calculated, the marker configuring unit 30 may be configured to convert the position information Pᵣ, into the position information Sᵣ, based on the moving object coordinate system by reflecting a moving vector v between the center coordinate of the vehicle and center coordinate of the infrared transceiver 10 therein (S330).

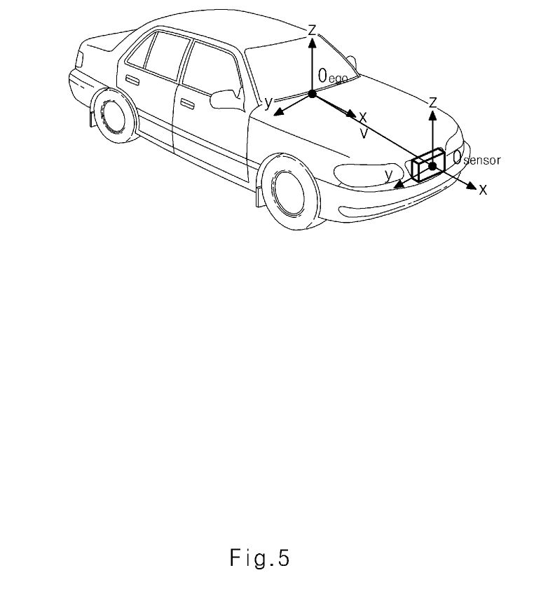

FIG. 5 is an exemplary diagram illustrating a relationship between the center of a vehicle and center of a sensor when the sensor is mounted in the vehicle which is a moving object. When the moving vector between the center coordinate O_{ego} of the vehicle and center coordinate Oₛₑₙₛₒᵣ of the infrared transceiver 10 is v, the position information Sₙ based on the moving object coordinate system may be calculated using the following Equation 2.

Sₙ=v+Pₙ

In particular, the moving vector v may be determined by an initial design condition. When coordinate conversion is calculated, the marker configuring unit 30 may be configured to create the road map and define the marker shape using the position information Sₙ, the signal strength information, and the speed information of the vehicle (S340).

When the signal strength of the reflection beam is Iₙ, the map information may be represented by the following Equation 3 by combining the position information Sₙ and the signal strength Iₙ of the position.

Mₙ=(SₙIₙ)

Furthermore, the infrared transceiver 10 may be configured to irradiate the infrared beam and receive the reflected beam with a predetermined time interval (Δt) while moving at a speed which is substantially the same as the speed V of the vehicle, to allow the marker configuring unit 30 to obtain the map information M_{n,t1} at initial time t1 and then obtains the map information M_{n,t1} on the position moved by a time of t(t2−t1) at the speed of V. The map information may be repeatedly created M_{n,t1}˜M_{n,tk} at a predetermined time interval until data is collected allowing the road marker to be recognized.

The map information M_{n,t1}−M_{n,tk} may be obtained using the following Equation 4.

M_{n,t}_{₁}=(S_{n,t}_{₁},Iₙ)ₜ_{₁}

M_{n,t}_{₂}=(S_{n,t}_{₁}+V·(t₂−t₁)Iₙ)ₜ_{₂}

M_{n,t}_{₃}=(S_{n,t}_{₁}+V·(tₖ−tₖ₋₁)i Iₙ)t_{₁} k=1, . . . , K

The marker configuring unit 30 may be configured to arrange, in a time sequence, the map information M_{n,t1}˜M_{n,tk} repeatedly obtained with the predetermined time interval to create the road map, and may be configured to represent the shape of the corresponding marker on the road map when the marker exists at a corresponding region.

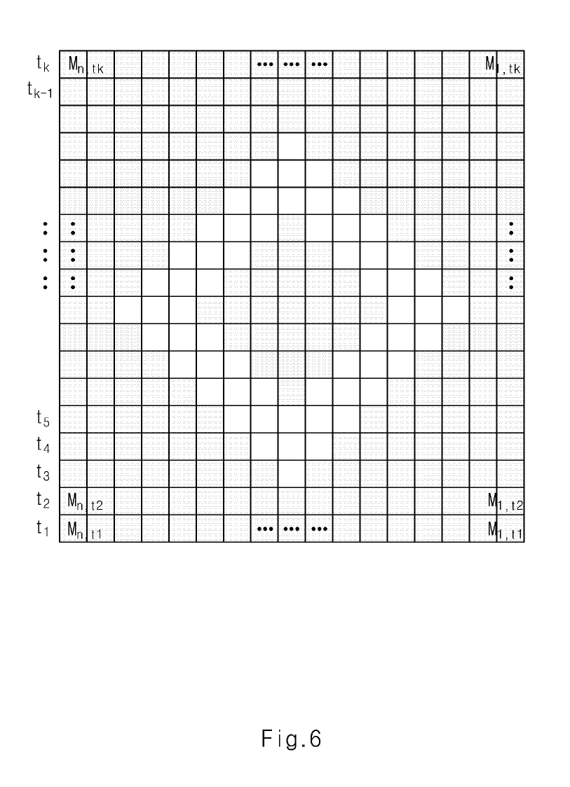

FIG. 6 is an exemplary diagram illustrating an example of a marker shaped on a road map and the shape may have a rhombus pattern. The marker configuring unit 30 may be configured to transmit the marker shape defined as described above to the matching unit 50. Additionally, the matching unit 50 may be configured to compare the shape received from the marker configuring unit 30 with the marker information stored in the pattern DB 40, and may be configured to output the information regarding the corresponding marker to the driver after determining the definition of the shape received from the marker configuring unit 30 (S350).

Furthermore, the matching unit 50 may be configured to output the marker information using a speaker or may be configured to display the corresponding marker on a screen together with the voice from the speaker. For example, as shown in FIG. 6, when the marker shape is a rhombus pattern, the matching unit 50 may output the phrase “Beware of crosswalk on the front”. In addition, when is the controller determines that the current speed of the vehicle is faster than 80 Km/h and the marker shape indicates a speed limit of “80”, the matching unit 50 may be configured to display the number “80” repeatedly on the screen together with voice alarm outputting the phrase “The speed limit is 80. Reduce the speed”.

Therefore, the road marker recognition device and method according to the exemplary embodiment of the present invention may more accurately recognize the information marked on the road surface and provide the recognized information to the driver.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the accompanying claims.

What is claimed is:

1. A road surface marker recognition device comprising:
an infrared transceiver configured to:
irradiate an infrared beam on a road surface;
receive the reflected beam to detect a distance from a road surface and a strength of the reflected beam; and
a controller configured to:
create a road map of the road using distance information, signal strength information, and speed information of a vehicle;
define a marker shape on the road;
compare the defined marker shape with stored marker information to determine a definition of the marker shape; and
output the definition of the marker shape.

2. The road marker recognition device of claim 1, wherein the controller is further configured to:
obtain first position information based on a sensor coordinate system using the distance information;
obtain an angle at which the infrared beam is irradiated;
obtain an angular resolution; and
perform a coordinate conversion of the first position information into second position information based on a moving object coordinate system.

3. The road marker recognition device of claim 2, wherein the controller is configured to perform the coordinate conversion of the first position information into the second position information using a moving vector between a center coordinate of the vehicle and a center coordinate of the infrared transceiver.

4. The road marker recognition device of claim 2, wherein the controller is further configured to:
obtain map information with a predetermined time interval using the second position information and the signal strength information; and
continuously arrange generated map information in a time sequence to create the road map and define the marker shape on the road map.

5. The road marker recognition device of claim 1, wherein the infrared transceiver is configured to irradiate the infrared beam to a predetermined width of the road with a predetermined period by using a scanning scheme.

6. A road marker recognition method in a vehicle, the method comprising:
irradiating, by an infrared transceiver, an infrared beam on a road surface;
receiving, at the infrared transceiver, the beam reflected from the road to obtain distance information from the road and signal strength information of the reflected beam;
creating, by a controller, a road map for the road surface using the distance information, the signal strength information, and speed information of the vehicle;
defining, by the controller, a marker shape of the road surface;
comparing, by the controller, the marker shape with stored marker information to determine a definition of the marker shape; and
outputting, by the controller, the definition of the marker.

7. The method of claim 6, wherein creating a road map for the road surface further comprises:
obtaining, by the controller, first position information based on a sensor coordinate system using the distance information, an angle at which the infrared beam is irradiated, and an angular resolution;
performing, by the controller, a coordinate conversion of the first position information into the second position information based on a moving object coordinate system using a moving vector between a center coordinate of the vehicle and a center coordinate of an infrared transceiver;
obtaining, by the controller, map information with a predetermined time interval using the second position information and the signal strength information; and
continuously arranging, by the controller, the map information in a time sequence.

8. A non-transitory computer readable medium containing program instructions executed by a processor or controller, the computer readable medium comprising:
program instructions that control an infrared transceiver to irradiate an infrared beam on a road surface;
program instructions that control the infrared transceiver to receive the beam reflected from the road to obtain distance information from the road and signal strength information of the reflected beam;
program instructions that create a road map for the road surface using the distance information, the signal strength information, and speed information of the vehicle;
program instructions that define a marker shape of the road surface;
program instructions that compare the marker shape with stored marker information to determine a definition of the marker shape; and
program instructions that output the definition of the marker.

9. The non-transitory computer readable medium of claim 8, further comprising:
program instructions that obtain first position information based on a sensor coordinate system using the distance information, an angle at which the infrared beam is irradiated, and an angular resolution;
program instructions that perform a coordinate conversion of the first position information into the second position information based on a moving object coordinate system using a moving vector between a center coordinate of the vehicle and a center coordinate of an infrared transceiver;
program instructions that obtain map information with a predetermined time interval using the second position information and the signal strength information; and
program instructions that continuously arrange the map information in a time sequence.
